(19) United States
(12) Patent Application Publication
(10) Pub. No.: US 2026/0070349 A1
(43) Pub. Date: Mar. 12, 2026

(54) SYSTEM AND METHOD FOR HOLLOW VESSEL PRINTING

(71) Applicant: INK CUPS NOW LLC, Danvers, MA (US)

(72) Inventor: Ian Bedford, Gloucester, MA (US)

(21) Appl. No.: 19/316,250

(22) Filed: Sep. 2, 2025

Related U.S. Application Data
(60) Provisional application No. 63/692,223, filed on Sep. 9, 2024.

(51) Int. Cl. B41J 11/00; B41J 2/45

(52) U.S. Cl. CPC B41J 11/00212; B41J 2/451; B41J 11/00214; B41J 11/00218

(57) ABSTRACT

A direct to shape (DTS) printer including a plurality of inkjet print head channels configured to deposit ink on an external surface of the vessel and at least one laser pinning module configured to provide light having a first peak power density to at least partially cure the ink deposited on the surface of the vessel to enable further printing before final curing is disclosed. The DTS printer can also include a final curing module configured to provide light having a second peak power density to fully cure the ink deposited on the surface of the vessel.

### CROSS-REFERENCE TO RELATED APPLICATION

This application claims priority under 35 USC § 119(e) to U.S. Provisional patent application Ser. No. 63/692,223, titled “SYSTEM AND METHOD FOR HOLLOW VESSEL PRINTING,” filed Sep. 9, 2024, which is incorporated by reference herein in its entirety for all purposes.

### BACKGROUND

### 1. Field

Embodiments of the present disclosure relate generally to the printing of images on the exterior of axially symmetrical articles of manufacture using direct to shape inkjet printing technology.

### 2. Discussion of Related Art

As is known in the art, several techniques can be utilized to print images on manufactured goods, such as drink containers. These containers are made of various materials, such as plastics, metals, and glass. One known technique is to directly print onto the container surface, sometimes referred to as “direct-to-shape” (DTS) printing. There are two common mechanical configurations for DTS printers. In one configuration, the vessel to be printed is rotated and moved relative to fixed print heads. In an alternative configuration, the vessel is rotating but fixed axially while a carriage comprised of a plurality of print heads moves along the axial direction of the vessel. Direct printing on containers poses challenges. One challenge is that the containers themselves are made of materials that are difficult to image. Inks of special chemical blends and additives must be used, sometimes in the presence of active drying or hardening processes such as fast-curing using ultra-violet (UV) radiation. However, stray or reflected UV radiation can cause issues such as curing or clogging the ink jet heads. Also, UV light from the curing lamp(s) can travel through the object and damage or clog the print heads. Further, the printing process must take into account the irregular and varied shapes of the containers that are to be printed.

### SUMMARY

An aspect of the present disclosure is directed to a direct to shape (DTS) printer configured to print on a surface of a vessel. The DTS printer includes a plurality of inkjet print head channels configured to deposit ink on the surface of the vessel, a rotary drive assembly configured to rotate the vessel relative to the plurality of inkjet print head channels, and at least one laser pinning module laser pinning module configured to provide light having a first peak power density to sufficiently cure the ink deposited on the surface of the vessel. The DTS printer also includes a final curing lamp configured to provide light having a second peak power density to fully cure the ink deposited on the surface of the vessel.

In an embodiment, the second peak power density is greater than the first peak power density.

An aspect of the present disclosure is directed to a direct to shape (DTS) printer configured to print on a surface of a vessel. The DTS printer includes a plurality of inkjet print heads configured to deposit ink on the surface of the vessel, a rotary drive assembly configured to rotate the vessel relative to the plurality of inkjet print heads, at least one laser pinning module laser pinning module configured to provide light having a first peak power density to sufficiently (at least partially) or fully cure the ink deposited on the surface of the vessel, and a final curing lamp configured to provide light having a second peak power density to further cure the ink deposited on the surface of the vessel, the second peak power density being greater than the first peak power density.

An embodiment provides that the final curing lamp is located such that its radiation doesn't reach any of the print heads or such that the final curing lamp is not enabled at a time that light from the curing lamp can expose the print heads (if moving axially with the vessel) so that the print heads are not exposed to the final curing light.

In one embodiment, the DTS printer includes a linear drive assembly configured to move the vessel along an axis adjacent to the plurality of inkjet print heads. In some embodiments, the at least one laser pinning module laser pinning module is configured to sufficiently (at least partially) cure the ink deposited on the surface of the vessel. In certain embodiments, the curing lamp is configured to be off until the vessel is moved away from the plurality of inkjet print heads. In various embodiments, the at least one laser pinning module laser pinning module is positioned with respect to the plurality of inkjet print heads such that the light provided by the at least one laser pinning module laser pinning module is reflected off the surface of the vessel away from the plurality of inkjet print heads.

In some embodiments, the at least one laser pinning module laser pinning module is positioned to provide light to the surface of the vessel at an incident angle that is less than a critical angle corresponding to a material of the vessel. In certain embodiments, the DTS printer includes a light trap configured to absorb or dampen the light reflected off the surface of the vessel. The at least one laser pinning module is configured to provide the light having the first peak power density at a substantially constant level over an operational distance range. In various embodiments, the position of the at least one laser pinning module is configured to be adjusted such that a maximum working distance between the at least one laser pinning module and the surface of the vessel is within the operational distance range of the at least one laser pinning module, and wherein the maximum working distance corresponds to the position of the at least one laser pinning module and a shape of the vessel. In some embodiments, the curing lamp is positioned beneath the vessel. In certain embodiments, the DTS printer is configured to print a vessel that is hollow and transparent.

Embodiments of the system include a UV sensor that is located near the print head nozzles that senses the amount of light exposure from the at least one laser pinning module and that provides the sensed amount of light information to a controller that is used to control the amount of light output from the at least one laser pinning module to ensure the alignment of the at least one laser pinning module, in conjunction with the vessel geometry, and to ensure that the level of emitted light does not result in radiation levels high enough to cure ink in the print head nozzles as this can damage the head or degrade image quality.

An aspect of the disclosure is directed to method of printing on a surface of a vessel. The method comprises rotating the vessel relative to a plurality of inkjet print head channels using a rotary drive assembly, depositing ink from the plurality of inkjet print head channels on the surface of the vessel, and providing light having a first peak power density from at least one laser pinning module to sufficiently cure the ink deposited on the surface of the vessel. The method also includes providing light having a second peak power density from a curing lamp to fully cure the ink deposited on the surface of the vessel.

Embodiments include providing light from curing lamp at the second peak power density that is greater than the light provided by the at least one laser pinning module at the first peak power density.

An aspect of the present disclosure is directed to a method of printing on the surface of a vessel including rotating the vessel relative to a plurality of inkjet print heads using a rotary drive assembly, depositing ink from a plurality of inkjet print heads on the surface of the vessel, providing light having a first peak power density from at least one laser pinning module to sufficiently (at least partially) or fully cure the ink deposited on the surface of the vessel, and providing light having a second peak power density from a curing lamp to fully cure the ink deposited on the surface of the vessel, the second peak power density being greater than the first peak power density.

In one embodiment, the method includes moving the vessel along an axis adjacent to the plurality of inkjet print heads using a linear drive assembly. In some embodiments, the curing with the at least one laser pinning module comprises sufficiently (at least partially) or fully curing the ink deposited on the surface of the vessel. In certain embodiments, the method includes keeping the curing lamp turned off until the vessel is moved away from the plurality of inkjet print heads. In various embodiments, adjusting a position of the at least one laser pinning module such that the light provided by the at least one laser pinning module is reflected off the surface of the vessel away from the plurality of inkjet print heads.

An embodiment includes three laser pinning modules which can be in series to perform sufficient (at least partial) curing of ink on the vessel. One advantage of having three or more laser pinning modules is that it provides for each laser pinning module to be configured and controlled separately to provide less peak output power than a single laser pinning module arrangement, which provides for providing the total dose of light (power*time) to sufficiently (at least partially) cure the ink while also providing for less light being provided to the print heads so as to avoid any curing ink in the print heads.

An embodiment includes multiple laser pinning modules mechanically aligned in parallel. With multiple laser pinning modules, each laser pinning module is configured and controlled to be controlled separately to provide lower irradiance power than a single laser pinning module arrangement, which provides for providing the total dose of light (power*time) to sufficiently (at least partially) cure the ink while also providing for less light being provided to the print heads so as to avoid any curing ink in the print heads.

In some embodiments, adjusting the position of the at least one laser pinning module further includes positioning the at least one laser pinning module to provide light to the surface of the vessel at an incident angle that is less than a critical angle corresponding to a material of the vessel. In various embodiments, the method includes providing the light having the first peak power density at a substantially constant level over an operational distance range. In one embodiment, the method includes positioning the at least one laser pinning module such that a maximum working distance between the at least one laser pinning module and the surface of the vessel is within the operational distance range of the at least one laser pinning module, and wherein the maximum working distance corresponds to the position of the at least one laser pinning module and a shape of the vessel. In certain embodiments, the method includes printing on a vessel that is hollow and transparent.

An aspect of the disclosure is directed to a direct to shape (DTS) printer configured to print on a surface of a vessel. The DTS printer includes a plurality of inkjet print head channels configured to deposit ink on the surface of the vessel, a rotary drive assembly configured to rotate the vessel relative to the plurality of inkjet print head channels, and a pinning means for sufficiently curing the ink deposited on the surface of the vessel. The DTS printer also includes a curing lamp positioned orthogonal to the vessel and configured to provide light to fully cure the ink deposited on the surface of the vessel.

In some embodiments, the pinning means includes means for providing light for sufficiently curing the ink at a first power density and the light provided by the curing lamp at the second peak power density is greater than the light provided by the first peak power density.

In some embodiments, the DTS printer further comprises means for moving the pinning means with the print head carriage assembly to irradiate the vessel to sufficiently cure an image printed on the vessel.

In some embodiments, the means for sufficiently curing comprises sufficiently curing the ink on the vessel such that the printed image on the vessel can be coated with a varnish without affecting the printed image.

In some embodiments, the means for sufficiently curing comprises fully curing the ink deposited on the surface of the vessel.

In some embodiments, the DTS printer further comprises means for sensing an amount of light exposure near the print head channels and controlling the amount of light output from the means for sufficiently curing to ensure that the level of emitted light does not result in radiation levels high enough to cure ink in the print head channels.

In some embodiments, the DTS printer further comprises means for adjusting a position of the means for sufficiently curing such that the light provided is reflected off the surface of the vessel away from the plurality of inkjet print head channels.

In some embodiments, the means for positioning further includes positioning the means for sufficiently curing to provide light to the surface of the vessel at an incident angle that is less than a critical angle corresponding to a material of the vessel.

In some embodiments, the means for sufficiently curing further comprising means for providing the light having the first peak power density at a substantially constant level over an operational distance range.

In some embodiments, the DTS printer further comprises means for positioning the means for sufficiently curing such that a maximum working distance between the means for sufficiently curing and the surface of the vessel is within an operational distance range of the means for sufficiently curing.

Another aspect of the present disclosure is directed to a direct to shape (DTS) printer configured to print on a surface of a vessel. The DTS printer includes a plurality of inkjet print heads configured to deposit ink on the surface of the vessel, a rotary drive assembly configured to rotate the vessel relative to the plurality of inkjet print heads, a curing lamp positioned beneath the vessel and configured to provide light to fully cure the ink deposited on the surface of the vessel, and means for pinning the ink deposited on the surface of the vessel and for keeping the curing lamp off until the vessel is moved away from the plurality of inkjet print heads.

In some embodiments, the means for pinning the ink deposited on the surface of the vessel includes means for sufficiently (at least partially) or fully curing the ink while preventing the plurality of inkjet print heads from being damaged.

Another aspect of the present disclosure is directed to a direct to shape (DTS) printer configured to print on a surface of a vessel. The DTS printer includes a plurality of inkjet print heads configured to deposit ink on the surface of the vessel, a linear drive assembly configured to move the vessel along an axis adjacent to the plurality of inkjet print heads, a rotary drive assembly configured to rotate the vessel relative to the plurality of inkjet print heads, at least one laser pinning module configured to provide light having a first peak power density to sufficiently (at least partially) or fully cure the ink deposited on the surface of the vessel, and a curing lamp configured to provide light having a second peak power density to fully cure the ink deposited on the surface of the vessel, the second peak power density being greater than the first peak power density.

In one embodiment, the at least one laser pinning module is configured to sufficiently (at least partially) or fully cure the ink deposited on the surface of the vessel. In some embodiments, the final curing lamp is configured to be off until the vessel is moved away from the plurality of inkjet print heads. In some embodiments, the final curing lamp is located such that its radiation doesn't reach any of the print heads. In some embodiments, the final curing lamp is not enabled at a time that light from the curing lamp can expose the print heads so that the print heads are not exposed to the final curing light.

In various embodiments, the at least one laser pinning module is positioned with respect to the plurality of inkjet print heads such that the light provided by the at least one laser pinning module is reflected off the surface of the vessel away from the plurality of inkjet print heads. In certain embodiments, the at least one laser pinning module is positioned to provide light to the surface of the vessel at an incident angle that is less than a critical angle corresponding to a material of the vessel.

In some embodiments, the DTS printer includes a light trap configured to absorb or dampen the light reflected off the surface of the vessel. In certain embodiments, the at least one laser pinning module is configured to provide the light having the first peak power density at a substantially constant level over an operational distance range. In one embodiment, the position of the at least one laser pinning module is configured to be adjusted such that a maximum working distance between the at least one laser pinning module and the surface of the vessel is within the operational distance range of the at least one laser pinning module, and wherein the maximum working distance corresponds to the position of the at least one laser pinning module and a shape of the vessel. In various embodiments, the curing lamp is positioned beneath the vessel. In one embodiment, the DTS printer is configured to print a vessel that is hollow and transparent.

Another aspect of the disclosure is directed to a method of printing on the surface of a vessel including moving the vessel along an axis adjacent to a plurality of inkjet print heads using a linear drive assembly, rotating the vessel relative to the plurality of inkjet print heads using a rotary drive assembly, depositing ink from a plurality of inkjet print heads on the surface of the vessel, providing light having a first peak power density from at least one laser pinning module to cure the ink deposited on the surface of the vessel, and providing light having a second peak power density from a curing lamp to fully cure the ink deposited on the surface of the vessel, the second peak power density being greater than the first peak power density.

In some embodiments, the curing with at least one laser pinning module assembly includes sufficiently (at least partially) or fully curing the ink deposited on the surface of the vessel. In one embodiment, the method includes keeping the curing lamp turned off until the vessel is moved away from the plurality of inkjet print heads. In various embodiments, the method includes adjusting a position of the at least one laser pinning module such that the light provided by the at least one laser pinning module is reflected off the surface of the vessel away from the plurality of inkjet print heads. In certain embodiments, adjusting the position of the at least one laser pinning module further includes positioning the at least one laser pinning module to provide light to the surface of the vessel at an incident angle that is less than a critical angle corresponding to a material of the vessel.

In one embodiment, the method includes providing the light having the first peak power density at a substantially constant level over an operational distance range. In some embodiments, the method includes positioning the at least one laser pinning module such that a maximum working distance between the at least one laser pinning module and the surface of the vessel is within the operational distance range of the at least one laser pinning module, and wherein the maximum working distance corresponds to the position of the at least one laser pinning module and a shape of the vessel. In certain embodiments, the method includes printing on a vessel that is hollow and transparent. In some embodiments, the method includes aligning an axis of the at least one laser pinning module with a rotational axis of a tapered vessel to ensure a sufficient amount of radiation is provided to the vessel.

Another aspect of the disclosure is directed to a direct to shape (DTS) printer configured to print on a surface of a vessel. The DTS printer includes a plurality of inkjet print heads configured to deposit ink on the surface of the vessel, a linear drive assembly configured to move the vessel along an axis adjacent to the plurality of inkjet print heads, a rotary drive assembly configured to rotate the vessel relative to the plurality of inkjet print heads, a curing lamp positioned beneath the vessel and configured to provide light to fully cure the ink deposited on the surface of the vessel, and means for pinning the ink deposited on the surface of the vessel and for keeping the curing lamp off until the vessel is moved away from the plurality of inkjet print heads.

In one embodiment, the means for pinning the ink deposited on the surface of the vessel includes means for sufficiently (at least partially) or fully curing the ink while preventing the plurality of inkjet print heads from being damaged by the curing radiation. Another aspect of the disclosure is directed to a direct to shape (DTS) printer configured to print on a surface of a vessel. The DTS printer includes a plurality of inkjet print heads configured to deposit ink on the surface of the vessel, a linear drive assembly configured to move the vessel along an axis adjacent to the plurality of inkjet print heads, a rotary drive assembly configured to rotate the vessel relative to the plurality of inkjet print heads, at least one laser pinning module configured to provide light having a first peak power density to sufficiently (at least partially) or fully cure the ink deposited on the surface of the vessel, and a curing lamp positioned beneath the vessel configured to provide light having a second peak power density to fully cure the ink deposited on the surface of the vessel, the second peak power density being greater than the first peak power density.

In some embodiments, the at least one laser pinning module is configured to sufficiently (at least partially) or fully cure the ink deposited on the surface of the vessel such that the curing lamp can remain turned off until the vessel is moved away from the plurality of inkjet print heads. In one embodiment, the at least one laser pinning module assembly is positioned with respect to the plurality of inkjet print heads such that the light provided by the at least one laser pinning module is reflected off the surface of the vessel away from the plurality of inkjet print heads. In certain embodiments, the at least one laser pinning module is positioned to provide light to the surface of the vessel at an incident angle that is less than a critical angle corresponding to a material of the vessel. In some embodiments, the final curing lamp is located such that its radiation doesn't reach any of the print heads or such that the final curing lamp is not enabled at a time that light from the curing lamp can expose the print heads so that the print heads are not exposed to the final curing light. In one embodiment, the DTS printer includes a light trap configured to absorb or dampen the light reflected off the surface of the vessel. In various embodiments, the at least one laser pinning module is configured to provide the light having the first peak power density at a substantially constant level over an operational distance range. In certain embodiments, the position of the at least one laser pinning module is adjusted such that a maximum working distance between the at least one laser pinning module and the surface of the vessel is within the operational distance range of the at least one laser pinning module. In some embodiments, the maximum working distance corresponds to the position of the at least one laser pinning module and a shape of the vessel. In one embodiment, the vessel is hollow and transparent.

Another aspect of the present disclosure is directed to a method of printing on the surface of a vessel including moving the vessel along an axis adjacent to a plurality of inkjet print heads using a linear drive assembly, rotating the vessel relative to the plurality of inkjet print heads using a rotary drive assembly, depositing ink from a plurality of inkjet print heads on the surface of the vessel, providing light having a first peak power density from at least one laser pinning module to sufficiently (at least partially) or fully cure the ink deposited on the surface of the vessel, and providing light having a second peak power density from a curing lamp positioned beneath the vessel to fully cure the ink deposited on the surface of the vessel, the second peak power density being greater than the first peak power density.

In one embodiment, the at least one laser pinning module is configured to sufficiently (at least partially) or fully cure the ink deposited on the surface of the vessel allowing the curing lamp to remain turned off until the vessel is moved away from the plurality of inkjet print heads. In some embodiments, the method includes adjusting a position of the at least one laser pinning module such that the light provided by the at least one laser pinning module is reflected off the surface of the vessel away from the plurality of inkjet print heads. In certain embodiments, adjusting the position of the at least one laser pinning module further includes positioning the at least one laser pinning module to provide light to the surface of the vessel at an incident angle that is less than a critical angle corresponding to a material of the vessel. In various embodiments, the at least one laser pinning module is configured to provide the light having the first peak power density at a substantially constant level over an operational distance range.

In some embodiments, adjusting the position of the at least one laser pinning module assembly further includes positioning the at least one laser pinning module such that a maximum working distance between the at least one laser pinning module and the surface of the vessel is within the operational distance range of the at least one laser pinning module. In certain embodiments, the maximum working distance corresponds to the position of the at least one laser pinning module and a shape of the vessel. In various embodiments, the vessel is hollow and transparent.

Another aspect of the present disclosure is directed to a direct to shape (DTS) printer configured to print on a surface of a vessel. The DTS printer includes a plurality of inkjet print heads configured to deposit ink on the surface of the vessel, a linear drive assembly configured to move the vessel along an axis adjacent to the plurality of inkjet print heads, a rotary drive assembly configured to rotate the vessel relative to the plurality of inkjet print heads, a curing lamp positioned beneath the vessel and configured to provide light to fully cure the ink deposited on the surface of the vessel, and means for pinning the ink deposited on the surface of the vessel allowing the main curing lamp to remain turned off until the vessel is moved away from the plurality of inkjet print heads.

Additional aspects and embodiments of the disclosure include that the various laser pinning module assemblies can be applied to machines providing multiple, in parallel, imaging tunnels comprising two or more printing paths.

In one embodiment, pinning the ink deposited on the surface of the vessel includes sufficiently (at least partially) or fully curing the ink while preventing the plurality of inkjet print heads from being damaged. In some embodiments, the vessel is hollow and transparent.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure. In the figures:

FIG. 1 is a schematic diagram illustrating one example of a single tunnel direct-to-shape (DTS) printer in accordance with aspects described herein;

FIG. 2 is a schematic diagram illustrating a direct-to-shape (DTS) printer in accordance with aspects described herein;

FIG. 3A is diagram illustrating one example of the final curing lamp positioning for a DTS printer curing ink printed on the surface of a vessel in accordance with aspects described herein;

FIG. 3B is diagram illustrating a DTS printer curing ink printed on the surface of a vessel where the vessel is stuffed to block the curing radiation from reaching the ink jet heads;

FIG. 4A is a schematic diagram illustrating a single tunnel DTS printer including at least one LED pinning module in accordance with aspects described herein;

FIG. 4B is a schematic diagram illustrating a DTS printer including a light trap in combination with a LED pinning module accordance with aspects described herein;

FIG. 5A is a diagram illustrating a vessel to be printed with a laser pinning module source and a light trap combination accordance with aspects described herein;

FIG. 5B is a schematic diagram illustrating a DTS printer including at least one laser pinning module in accordance with aspects described herein;

FIG. 5C is a schematic diagram one laser pinning module in accordance with aspects described herein illustrating a DTS printer including at least two laser pinning modules in series in accordance with aspects described herein;

FIG. 5D-5E illustrate a schematic diagram of a DTS printer including at least three laser pinning modules in series in accordance with aspects described herein;

FIG. 6 is a schematic diagram illustrating a DTS printer including at least one pinning module and a polygon scanner in accordance with aspects described herein;

FIG. 7A illustrates an example of perpendicular beam divergence of a laser diode according to an embodiment of a laser pinning diode;

FIG. 7B illustrates a parallel beam divergence of a laser diode according to an embodiment of a laser pinning diode;

FIG. 8A illustrates various views of a laser beam divergence of a laser pinning module along an illumination plane of the vessel, including a diagonal view, side view and top view according to an embodiment of a laser pinning module;

FIG. 8B illustrates a beam width and height according to an embodiment of a laser pinning module;

FIG. 9A is a diagram illustrating multiple perspective views of a laser pinning module arranged with respect to a vessel in accordance with aspects described herein;

FIG. 9B is a diagram illustrating multiple views of an embodiment with two laser pinning modules arranged with respect to a vessel in accordance with aspects described herein;

FIG. 9C is a diagram illustrating a perspective view of a laser pinning module with respect to a vessel in accordance with aspects described herein; and

FIG. 10A-10B illustrate a multiple tunnel DTS printer including two (FIG. 10A) and three (FIG. 10B) laser pinning module s in accordance with aspects described herein.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

As discussed above, several techniques can be utilized to print images on manufactured goods (e.g., containers), such as plastics, metals, and glassware. One example is to direct print onto the container surface, sometime referred to as “direct-to-shape” (DTS) printing. Inkjet DTS printing has over time become a preferred method for DTS printing, especially for package printing. Inkjet printing utilizes a digital printhead to print full color customized designs in one or multiple imaging passes and may be applied directly to the substrate surface of the object. The transfer occurs by propelling droplets of ink directly onto the substrate medium. The ink delivery mechanism is called the “printhead,” and is controlled by a digital image held by a computer system. However, the design of printheads in an inkjet system varies greatly.

The benefits of inkjet printing in DTS applications have driven a recent preference to use inkjet systems in product manufacturing lines. For example, inkjet printing requires less set-up time and allows for faster print and cure times. Inkjet printing also is configurable to allow printing on multiple items at once. Moreover, print jobs do not require fixed setup time and costs, such as the generation of screens or the installation of plates. Another advantage of inkjet printing is the ability to change graphic images quickly to adjust for printing results. Imaging software allows for the importation of graphics instantly. Hence, the flexibility of image alteration on a job-by-job basis is a distinct advantage.

However, direct printing on containers poses challenges. One challenge is that the containers themselves are made of materials that are difficult to image. Inks of special chemical blends and additives must be used, sometimes in the presence of active drying or hardening processes such as fast-curing using ultra-violet (UV) radiation. Further, the printing process must take into account the irregular and varied shapes of the containers that are to be printed. Such challenging print surfaces comprise a good many products, such as drink cans and bottles, cups, coffee tumblers to name just a few.

One type of inkjet system is specialized to print on the surface of cylindrical objects and are called “digital cylindrical presses.” For example, Ink Cups Now Corporation offers the Helix line of DTS printers. These printers use rotatable tool (sometimes a mandrel holding the inner wall of the cup or more typically, two tools that capture each end of the vessel) to hold an object and rotate the object next to an inkjet printhead as the printhead jets ink onto the surface of the cylindrical object. Such DTS printers can be configured to print on a variety of cylindrical objects including transparent objects such as spirit bottles, glassware, drinkware, and candle holders. The structure and operation of standard cylindrical DTS printing systems are fairly well understood in the printing industry and disclosed in, for example, representative patents U.S. Pat. Nos. 6,918,641B2 and 7,967,405B2.

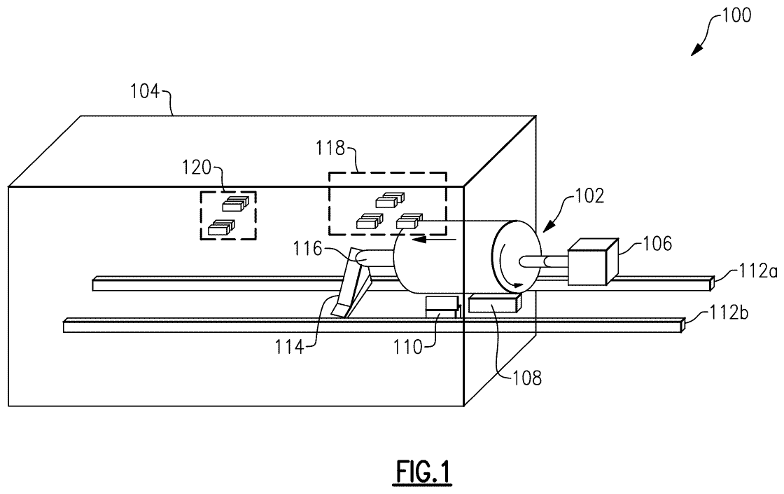

FIG. 1 illustrates a schematic diagram of an exemplary related art DTS printer 100 in accordance with aspects described herein. In FIG. 1, the DTS printer 100 is a digital cylindrical DTS printing system configured to print on the surface of a vessel 102. As shown, the DTS printer 100 includes a carriage tunnel 104, a rotary drive assembly 106, a linear drive assembly 108, a curing lamp 110, a first carriage rail 112a, a second carriage rail 112b, a carriage rail assembly 114, a nose cone or tail stock 116, and inkjet print heads 118. It is to be appreciated that a print head channel can include on or more inkjet print heads of one or more colors. It is also to be understood that herein the terms print heads and print head channels are used interchangeably, unless specifically noted or claimed to be a print head channel. In some examples, the DTS printer 100 includes one or more varnish print heads 120. A UV sensor can be disposed in a pocket next to a print head to sense when too much energy is reaching the print heads. In particular, the UV sensor that is located near the print head nozzles is configured to sense the amount of light exposure from at least one pinning lamp (not illustrated in FIG. 1) or a final curing lamp 110, and to provide the sensed amount of light information to a controller that is used to control the amount of light output from the pinning lamp(s) to ensure any or all of alignment of the pinning lamp(s), and to ensure that the level of emitted light does not result in radiation levels high enough to cure ink in the print head nozzles as this can damage the head and/or degrade image quality.

The DTS printer 100 is a stand-alone machine that performs non-contact printing of images on generally cylindrical objects (e.g., the vessel 102); however, in some examples, the DTS printer 100 can be configured to print images on different shaped objects. In some examples, the vessel 102 is a hollow cylindrical object or hollow partially cylindrical objects for example, a can or bottle, tapered drinkware, or curved objects with a circular cross section.

The vessel 102 is hand or robotically loaded and secured either by vacuum (not shown) on a mandrel 116 or by friction after both ends of the vessel are captured to prevent slippage, which assembly is attached to the carriage rail assembly 114 to linearly position the vessel 102 beneath the inkjet print heads 118. The vessel 102 is rotated below and in front of the inkjet print heads 118 while ink is deposited to the vessel 102 to produce a desired printed design on the vessel 102. The jetted ink on the vessel 102 is cured before printing more ink dots on the previous layer to avoid the ink from spreading on the vessel surface. The ink is either sufficiently (at least partially) or fully cured immediately after printing by exposing the ink to the curing lamp 110. In one example, the curing lamp 110 is an energy-emitting device, such as a UV light emitter, positioned directly beneath (positioned 180 degrees from the inkjet print heads 118) the vessel 102. Typical light emitters are LED arrays under 400 nm or mercury lamps.

The carriage rail assembly 114 is attached to the first and second carriage rails 112a, 112b and the linear drive assembly 108 is operated to slide the carriage rail assembly 114 (i.e., the vessel 102) along the first and second carriage rails 112a, 112b. The linear drive assembly 108 linearly advances the vessel 102 in a position adjacent to the inkjet print heads 118 such that a first portion of the vessel 102 may be printed (if the vessel length is longer than the length of the print heads). The vessel 102 is rotated via the tooling 116 and the rotary drive assembly 106 while the inkjet print heads 118 deposit ink from a supply of ink located above the vessel 102 (not shown). Simultaneously the curing lamp 110 below the vessel 102 either sufficiently (at least partially) or completely cures the ink. The linear drive assembly 108 then continues to advance the vessel 102 further such that the entire length of the vessel 102 is printed. In certain examples, the continuous advancement of the vessel 102 may not be necessary if the inkjet print heads 118 are longer than the image desired to be printed on the vessel 102.

In some examples, the image itself comprises a digital image. A print engine running on the DTS printer 100 or an associated computer system controls the delivery of ink onto the vessel 102 via the inkjet print heads 118 as the object is moved past the inkjet print heads 118 in a digitally controlled manner. In one example, the inkjet print heads 118 correspond to a set of CMYKW (Cyan, Magenta, Yellow, Black, and White) print channels. However, in other examples, the inkjet print heads 118 may correspond to a different color model (e.g., RGB) or the CMYKW might have additional colors (light cyan, light black, and light magenta to improve skin tones or orange, violet, and green to expand the color gamut printed. In certain examples, once the desired printed design has been deposited on the vessel 102 and cured, varnish print heads 120 may apply a coating of varnish to the vessel 102 for either a shiny finish or to build up a 3D effect to the print.

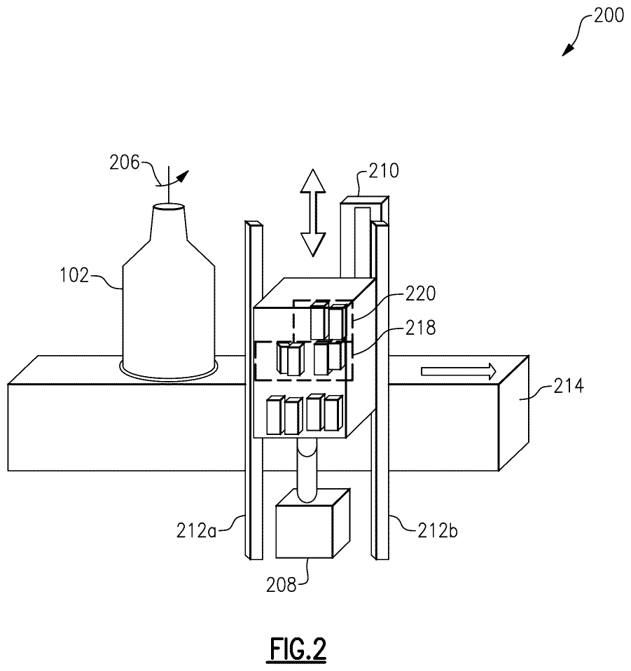

In other examples, alternative DTS printer configurations may be used to print on the surface of various objects (i.e., the vessel 102). For example, FIG. 2 illustrates a schematic diagram of a DTS printer 200 in accordance with aspects described herein. Similar to the DTS printer 100 of FIG. 1, the DTS printer 200 is a digital cylindrical DTS printing system configured to print on the surface of the vessel 102 but instead of the vessel moving axially, an ink jet carriage will move along the vessel's rotational axis. As shown, the DTS printer 200 includes a rotary drive assembly 206, a carriage drive assembly 208, a curing lamp 210, a first carriage rail 212a, a second carriage rail 212b, a linear conveyer assembly 214, and inkjet print heads 218. In some examples, the DTS printer 200 includes one or more varnish print heads 220.

The DTS printer 200 is a stand-alone machine that performs non-contact printing of images on generally cylindrical objects (e.g., the vessel 102); however, in some examples, the DTS printer 200 can be configured to print images on different shaped objects. In some examples, the vessel 102 is a hollow cylindrical object or hollow partially cylindrical objects for example, a can or bottle.

The vessel 102 is hand-loaded on the linear conveyer assembly 214 to linearly position the vessel 102 relative to the inkjet print heads 218. In some examples, the vessel 102 may be secured using a vacuum (not shown) to prevent slippage. The vessel 102 is rotated in front of the inkjet print heads 218 while ink is deposited to the vessel 102 to produce a desired printed design on the vessel 102. The jetted ink on the vessel 102 is cured by curing lamp 210 before printing more ink dots on the previous layer to avoid the ink from spreading on the vessel surface. The ink is either sufficiently (at least partially) or fully cured immediately after printing by exposing the ink to the curing lamp 210. In one example, the curing lamp 210 is an energy-emitting device, such as a UV light emitter.

The inkjet print heads 218 are attached to the first and second carriage rails 112a, 112b and the carriage drive assembly 208 is operated to slide the inkjet print heads 218 along the first and second carriage rails 212a, 212b. The carriage drive assembly 208 positions the inkjet print heads 218 adjacent to the vessel 102 such that the vessel 102 may be printed.

The vessel 102 is rotated via the rotary drive assembly 206 while the inkjet print heads 218 deposit ink from a supply of ink (not shown). Simultaneously the curing lamp 110 either sufficiently (at least partially) or completely cures the ink. The linear conveyor assembly 214 then continues to advance the vessel 102 further such that the entire vessel 102 is printed. In certain examples, the continuous advancement of the vessel 102 may not be necessary if the inkjet print heads 218 are longer than the image desired to be printed on the vessel 102.

In some examples, the image itself comprises a digital image. A print engine running on the DTS printer 200 or an associated computer system controls the delivery of ink onto the vessel 202 via the inkjet print heads 218 as the object is moved past the inkjet print heads 218 in a digitally controlled manner. In one example, the inkjet print heads 218 correspond to a set of CMYK (Cyan, Magenta, Yellow, Black) print heads; however, in other examples, the inkjet print heads 218 may correspond to a different color model (e.g., RGB). In certain examples, once the desired printed design has been deposited and cured on the vessel 102, the varnish print heads 220 may apply a coating of varnish to the vessel 102.

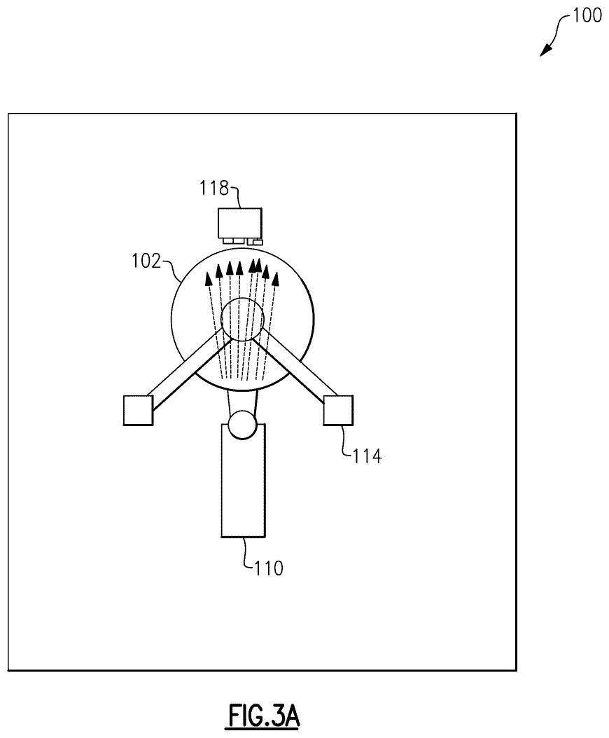

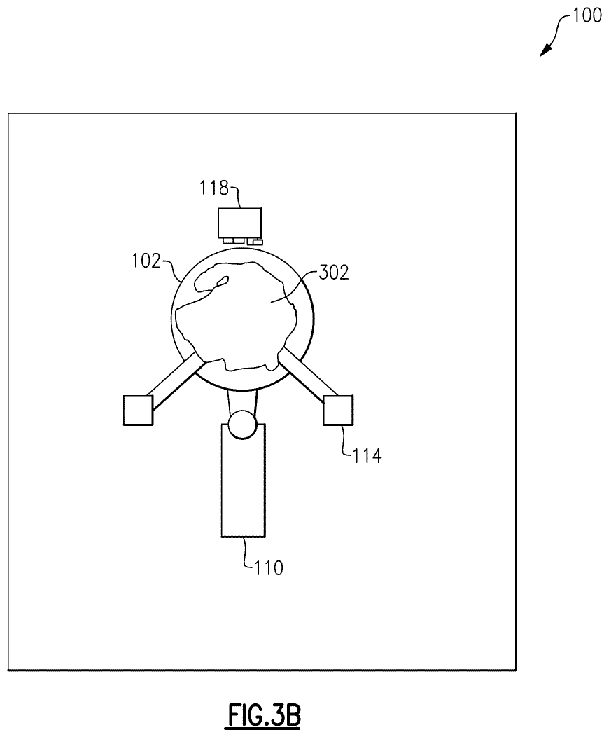

The DTS printers 100, 200 can provide printing of objects having a circular cross section while varying in diameter, including transparent objects such as spirit bottles, glassware, drinkware, and candle holders (i.e., vessel 102). However, an issue with printing transparent objects is that the UV light from the curing lamps 110, 210 must be kept away from the inkjet print heads 118, 218 to prevent ink from partially or fully curing within the print head nozzles. To illustrate the issue, as illustrated in FIG. 3A, while curing ink printed on the surface of a transparent object (i.e., the vessel 102), UV light from the curing lamp 110 can travel through the vessel 102 and reflect from the surface of vessel, but can also reach one or more of the inkjet print heads 118. As a result, ink may be cured within one or more of the print heads, blocking the nozzles of the print heads. In particular, if the nozzles get clogged, image quality will degrade or worse the inkjet print heads 118 can be damaged or ruined.

Referring to FIG. 3B, in some cases, light blocking and/or scattering materials can be inserted or stuffed in the vessel 102 to reduce the amount of UV light or radiation that reaches the inkjet print heads 118. As shown in FIG. 3B, a light blocking material 202 is stuffed in the vessel 102 to prevent at least a portion of the UV light from the curing lamp 110 from reaching the inkjet print heads 118. However, stuffing the vessel 102 with light block materials can be problematic. For example, stuffing the vessel 102 with light blocking materials can be time consuming and labor intensive. In some instances, the vessel 102 may have a geometry that prevents light blocking materials from being inserted and/or removed (e.g., small necked bottles). As such, an apparatus for curing ink on transparent objects/vessels that also prevents UV light from impinging upon the inkjet print heads 118 without having to insert a light blocking material into the objects/vessels is according to aspect and embodiments herein disclosed.

Accordingly, an improved printer system and method for hollow vessel printing is provided herein. In at least one embodiment, the printer system includes a laser pinning module configured to pin ink printed on the vessel surface prior to being fully cured by the curing lamp. In some examples, by using the laser pinning module to pin ink printed on the vessel surface, the curing lamp may be kept off until the printing process has completed and/or the vessel has been moved away from the print heads. In addition, the laser pinning module is positioned such that UV light is reflected away from the print heads to prevent the print heads from becoming clogged and/or damaged, eliminating the need to insert UV blocking materials in the vessel.

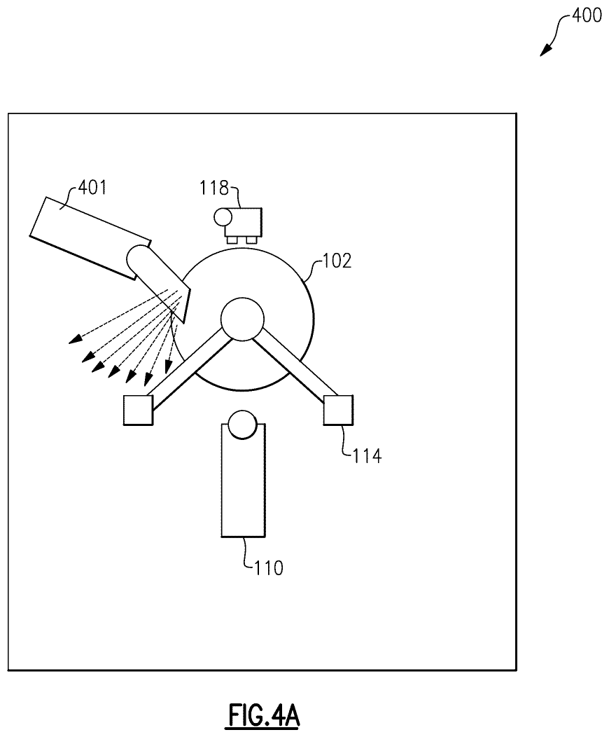

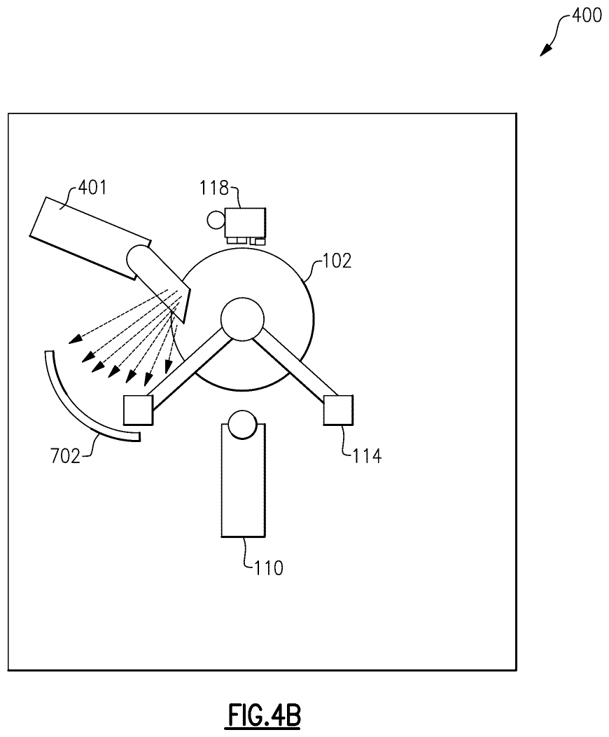

FIG. 4A illustrates a schematic diagram of a DTS printer 400 in accordance with aspects described herein. In this example, the DTS printer 400 is similar to the DTS printer 100 of FIGS. 1, 3A, and 3B, except the DTS printer 400 additionally includes an LED pinning module 401. The LED pinning module 401 is configured to provide UV light to sufficiently (at least partially) or fully cure or “pin” ink printed on the surface of the vessel 102 so as to at least enable additional printing without running or smearing of already printed ink. For example, in order to sufficiently (at least partially) or fully cure the ink printed on the surface of the vessel 102, the LED pinning module 401 provides a first power density of light that is less than the final curing lamp 110.

According to aspects and embodiments, in one example, the LED pinning module 401 is fixed to carriage tunnel assembly 114 and configured to have the vessel 102 move past the the print heads and the LED pinning module during imaging. In some examples, the LED pinning module 401 may be attached to carriage assembly 114 via an adjustable mount or bracket such that the position or angle of the laser pinning module and output light can be adjusted as needed. The LED pinning module mount or bracket may include gradations or markings indicating predetermined positions to guide a user in adjusting the angle of the LED pinning module 401. In other examples, the LED pinning module 401 may be attached to a different component of the DTS printer 400 (e.g., the carriage tunnel 104, carriage rails 112a, 112b, etc.).

Referring to FIG. 4B, according to some aspects and embodiments, to further prevent UV light from reaching the inkjet printheads 118, a light trap 702 can be positioned within the DTS printer 400 to capture reflected or stray UV light. For example, as shown in FIG. 4B, a light trap 702 is positioned to “trap” or absorb UV light that is reflected off the vessel 102 from the LED pinning module 401.

Referring to FIGS. 4A-B by way of example, aspects and embodiments of the system include a UV sensor that is located near the print head nozzles and print head channels. The UV sensor senses the amount of light exposure from the LED pinning module(s) and provides sensed amount of light information to a controller that is used to control the amount of light output from the laser pinning module(s) to ensure any or all of alignment of the laser pinning module(s) with the vessel geometry, and to ensure that the level of emitted light does not result in radiation levels high enough to cure ink in the print head nozzles, so as to avoid damage to the print head and/or a degraded image quality. However, it has been found that the embodiments of FIGS. 4A-4B suffer from stray or reflected UV radiation that causes issues such as curing or clogging the ink jet heads. Also, UV light from the LED curing lamp(s) can travel through the object and damage or clog the print heads.

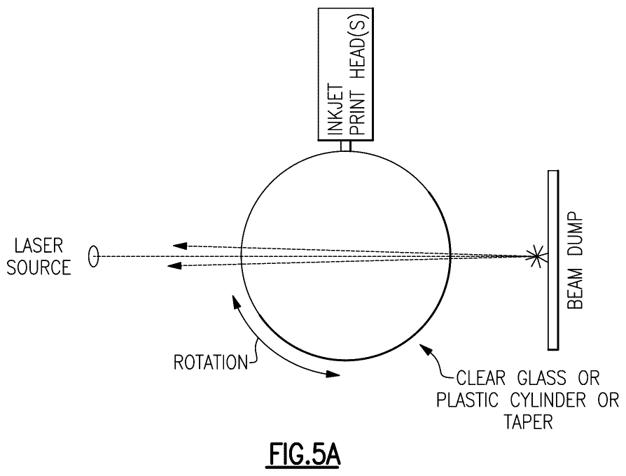

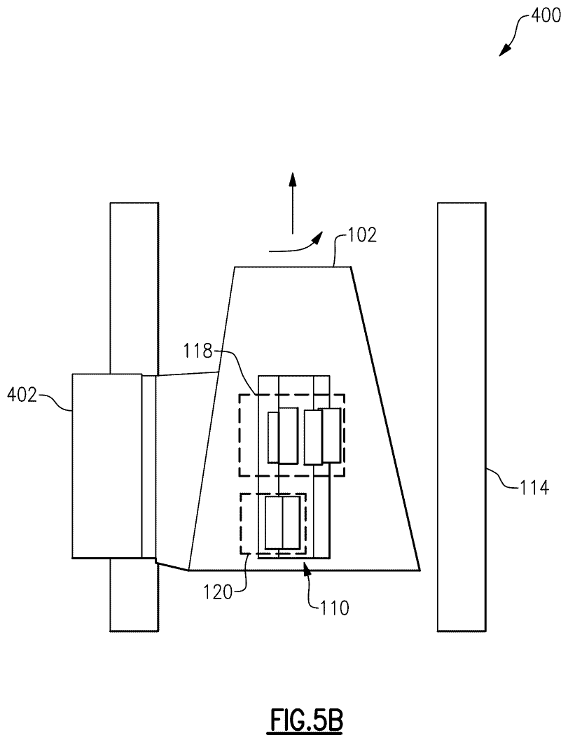

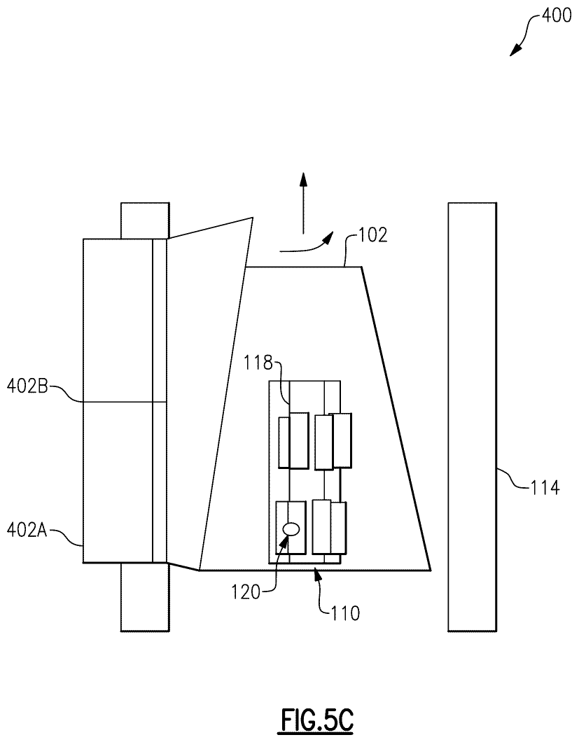

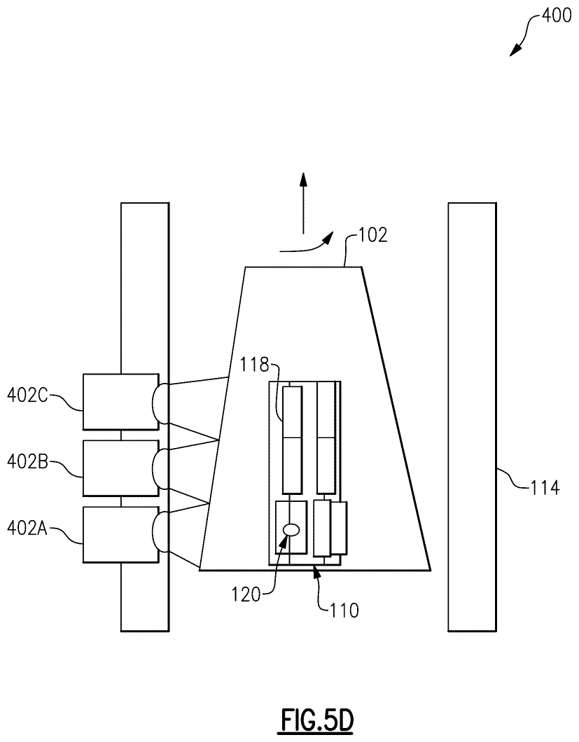

Referring to FIG. 5A, there is illustrated an end view of a vessel being printed with a laser pinning module (Laser Source) illustrated at one side of the vessel to be printed and a light trap (Beam dump) disposed at an opposing side of the vessel. In one example, the light trap is a non-reflective sheet or guard configured to absorb or dampen UV light. The light trap may be positioned to prevent UV light from reflecting off components of the DTS printer back towards the inkjet print heads. In some examples, the light trap is attached to the carriage rail assembly and configured to move with the vessel during printing; however, in other examples, the light trap may be stationary and attached to one of the carriage tunnels, the carriage rails, or a different component of the DTS printer.

In certain examples, the UV light provided by the laser source and laser pinning module 402 described herein may have a nominal wavelength of any of 355, 375, 385, 395, 405, 655 nm, or anywhere in a range of 340-655 nanometers (nm). According to a preferred embodiment of this disclosure, there is provided laser pinning module 402 that emits light at approximately 405 nm so as to sufficiently cure the ink used with the DTS printer. It is to be appreciated that according to aspects and embodiments of the disclosure, the wavelength of the at least laser pinning module 402 is configured to provide UV light having a wavelength selected to cure the ink being used.

FIG. 5B illustrates an overhead view of the DTS printer 400. As shown, the inkjet print heads 118 are configured to deposit ink on the surface of the vessel 102 while the vessel 102 is rotated (via the rotary drive assembly 106 not illustrated) and moved along the carriage rails (via the carriage rail assembly 114). As the vessel 102 is rotated/moved, the laser pinning module 402 at least partially cures the ink deposited on the surface of the vessel 102. In one example, the ink is sufficiently (at least partially) cured or fully cured such that the printing of the ink is maintained until the entire image or image layer has been deposited. As such, the final curing lamp 110 can remain turned off until the vessel 102 is moved away from the inkjet print heads 118 (e.g., to a loading position). Once the vessel 102 has been moved away from the inkjet print heads 118, the final curing lamp 110 can be turned on (i.e., illuminated) to fully cure the ink deposited on the surface of the vessel 102 without the risk of UV light reaching the inkjet print heads 118. After the ink has been fully cured, the final curing lamp 110 can be turned back off, and the vessel 102 may be moved back towards the inkjet print heads 118 for further printing (e.g., additional layers) or removed from the DTS printer 400.

In some examples, in order to account for variations in the surface of the vessel 102 (e.g., tapers, curves, etc.), the laser pinning module 402 may provide UV light with minimal power density variations over distance. For example, the laser pinning module 402 may be configured to provide a substantially constant power density at various distances between the laser pinning module 402 and the surface of the vessel 102. In certain examples, the laser pinning module 402 may be configured with a specialized lens designed to provide constant power density over the distance from the laser pinning module to the surface of the vessel by reducing peak radiation. In one example, the at least one laser pinning module 402 may be a KLC432FL01 WW laser diode, which emits up to 3.3 Watts of CW 402 nm laser light, is assembled in a conventional TO-9 CAN package and is sold by Nuvoton Technology Corporation. However, in other examples, any other type of laser diode may be utilized.

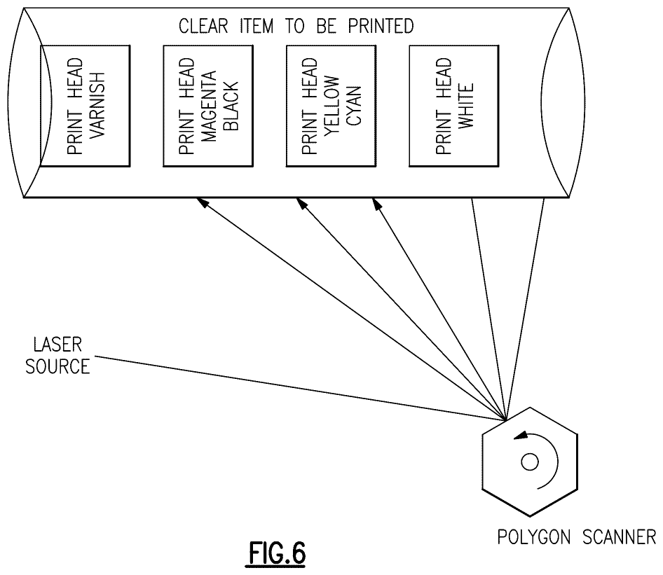

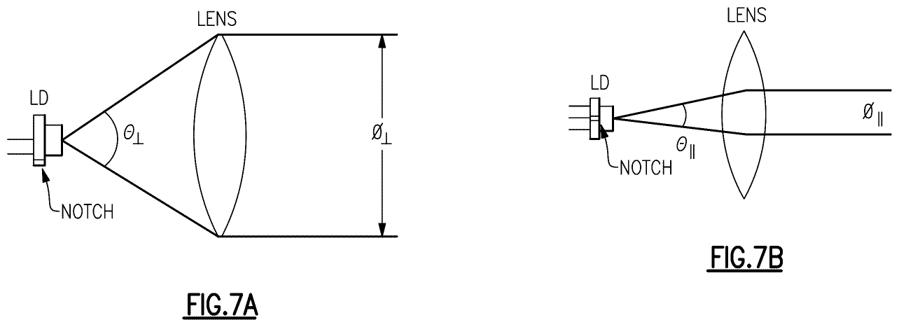

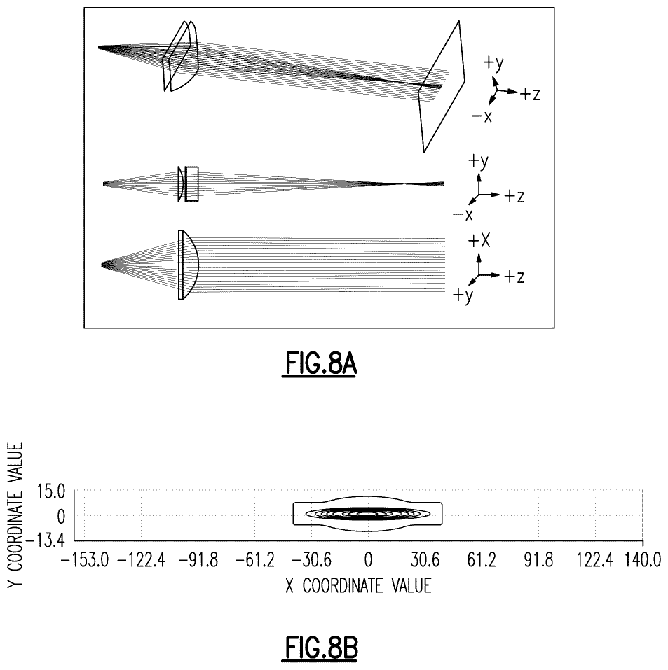

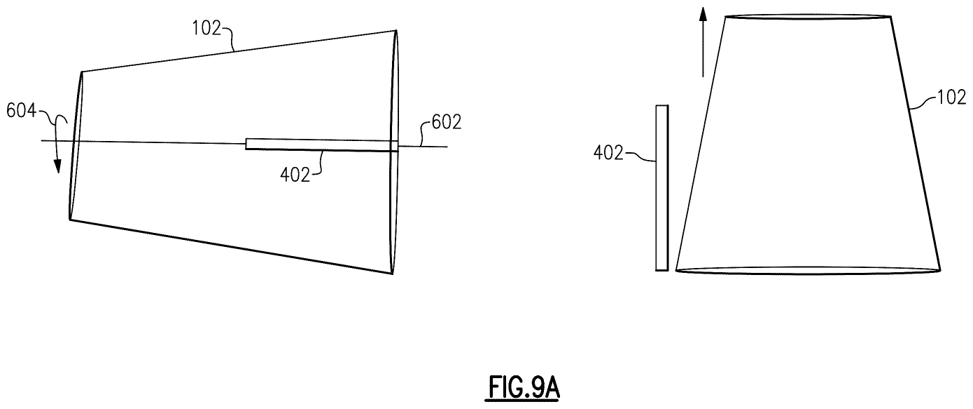

FIG. 7A illustrates an example of perpendicular beam divergence of a laser diode and FIG. 7B illustrates a parallel beam divergence of a laser pinning diode. According to aspect and embodiments, the laser pinning module is configured such that the perpendicular beam divergence of the laser pinning diode is configured to be along a length (direction of travel) of the vessel to be printed, and the parallel beam divergence of the laser pinning diode is along a height (direction of rotation) of the vessel to be printed. Referring now to FIG. 8A, there is illustrated various views of a laser beam divergence of a laser pinning module. In particular, FIG. 8A illustrates a diagonal view and a top view illustrating the perpendicular beam divergence of the laser diode is configured to be along a length of the illumination plane (X-axis), and that parallel beam divergence is configured to be along a height (Y-axis) of an illumination plane of the vessel. FIG. 8B illustrates a beam width (in mm) along the X-axis and the Y-axis according to an embodiment of a laser pinning module.

FIG. 5C illustrates an overhead view of another embodiment of the DTS printer 400. This embodiment includes two laser pinning modules 402A, 402B arranged in series. Like reference numbers correspond to like structure in other figures herein and for the sake of brevity a description of all of the elements may not be repeated. As shown, the inkjet print heads 118 are configured to deposit ink on the surface of the vessel 102 while the vessel 102 is rotated via the rotary drive assembly 106 (not illustrated) and moved along the carriage rails 112a, 122b (not illustrated) via the carriage rail assembly 114. As the vessel 102 is rotated/moved, the laser pinning modules 402A, 402B sufficiently (at least partially) or fully cures the ink deposited on the surface of the vessel 102 to allow additional printing of colors with the printing heads. In one example, the ink is sufficiently (at least partially) or fully cured by laser pinning modules 402A, 402B such that the position of the ink is maintained until the entire image or image layer has been deposited. As such, the final curing lamp 110 can remain turned off until the vessel 102 is moved away from the inkjet print heads 118 (e.g., to a loading position). Once the vessel 102 has been moved away from the inkjet print heads 118, the curing lamp 110 can be turned on (i.e., illuminated) to fully cure the ink deposited on the surface of the vessel 102 without the risk of UV light reaching the inkjet print heads 118. After the ink has been fully cured, the final curing lamp 110 can be turned back off, and the vessel 102 may be moved back towards the inkjet print heads 118 for further printing (e.g., additional layers) or removed from the DTS printer 400.

FIG. 5D illustrates an overhead schematic of another embodiment of the DTS printer 400. This embodiment includes at least three laser pinning modules 402A, 402B, 402C arranged in series. Like reference numbers correspond to like structure in other figures herein and for the sake of brevity a description of all of the elements may not be repeated. As shown, the inkjet print heads 118 are configured to deposit ink on the surface of the vessel 102 while the vessel 102 is rotated via the rotary drive assembly 106 (not illustrated) and moved along the carriage rails 112a, 122b (not illustrated) via the carriage rail assembly 114. As the vessel 102 is rotated/moved, the laser pinning modules 402A, 402B, 402C sufficiently cure (at least partially) or fully cure the ink deposited on the surface of the vessel 102 to allow additional printing of colors with the printing heads. In one example, the ink is sufficiently (at least partially) or fully cured by laser pinning modules 402A, 402B, 402C such that the position of the ink is maintained until the entire image or image layer has been deposited. As such, the final curing lamp 110 can remain turned off until the vessel 102 is moved away from the inkjet print heads 118 (e.g., to a loading position). Once the vessel 102 has been moved away from the inkjet print heads 118, the curing lamp 110 can be turned on (i.e., illuminated) to fully cure the ink deposited on the surface of the vessel 102 without the risk of UV light reaching the inkjet print heads 118. After the ink has been fully cured, the curing lamp 110 can be turned back off, and the vessel 102 may be moved back towards the inkjet print heads 118 for further printing (e.g., additional layers) or removed from the DTS printer 400.

FIG. 5E illustrates a Top View of another embodiment of the DTS printer. This embodiment includes three laser pinning modules (laser diodes) arranged in series and focused on the vessel to cure ink from a respective print head. As shown, three inkjet print heads are configured to deposit Magenta/Black ink, Yellow/Cyan ink, and White ink on the surface of the vessel while the vessel is rotated via the rotary drive assembly (not illustrated) and moved along the carriage rails (not illustrated) via the carriage rail assembly (not illustrated). As the vessel is rotated/moved, each laser pinning module is configured to sufficiently (at least partially) cure or fully cure the ink from a respective printing head deposited on the surface of the vessel to allow additional printing of colors with the printing heads. In one example, the ink is sufficiently (at least partially) or fully cured by the three laser pinning modules such that the position of the ink is maintained until the entire image or image layer has been deposited. As such, the final curing lamp can remain turned off until the vessel is moved away from the inkjet print heads (e.g., to a loading position). In the embodiment illustrated in FIG. 5E, the laser pinning modules are positioned at an angle of 7 degrees off axis parallel to the vessel to be printed. It is appreciated that according to aspects and embodiments, the laser pinning modules can be positioned at an angle of anywhere in a range from 5 to 15 degrees off axis.

According to aspects and embodiments disclosed herein, one laser diode is provided for each printing head. It is noted that each laser pinning module configuration can be comprised of a single laser diode or multiple laser diodes mechanically aligned in series, in parallel, or both. In addition, at least one or multiple laser pinning modules can be used to Pin cure the ink from multiple printing heads. With multiple laser pinning modules, lower irradiance (power) levels per laser pinning module can be used while maintaining a first total curing power dose, and more rows of printing heads or longer print heads can be supported. Using multiple laser pinning modules provides the ability to independently control each laser pinning module. With this arrangement, it is possible to optimize the balance of the pin curing power dose per print head illuminated on the ink printed on the vessel, while limiting the exposure to the printheads due to reflections or stray light.

It is appreciated that various aspects or embodiments can comprise two or more laser pinning modules, arranged either in series as illustrated in FIG. 4B, in a parallel arrangement one on each side of the vessel to be cured (not illustrated), or in both a series and parallel arrangement, such as for example four laser pinning modules in both a series and parallel arrangement, such as for example, two in series on each side of the vessel to be cured (not illustrated). According to aspects and embodiments, there could be at least five laser pinner modules, with one laser module configured to focus on white ink from a printhead, a second laser pinning module configured to focus on two of four colors from a first four color inkjet printhead, a third laser pinning module configured to focus on remaining two of four colors from the first four color inkjet printhead, a fourth laser pinning module configured to focus on two of four colors from a second four color inkjet printhead, a fifth laser pinning module configured to focus on remaining two of four colors from the second four color inkjet printhead.

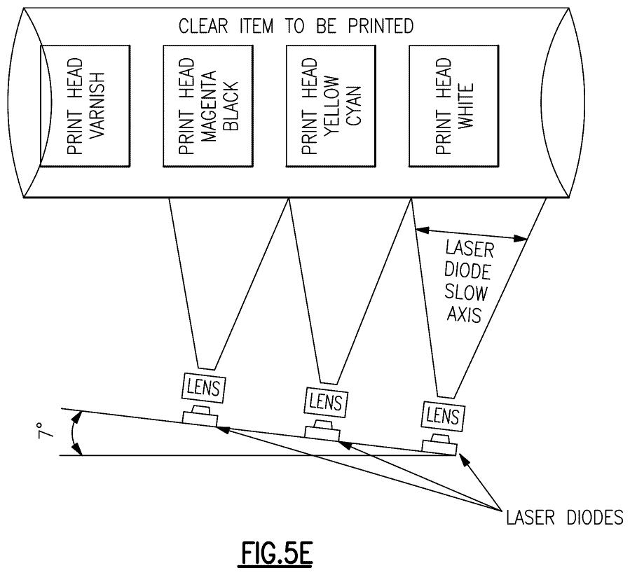

Referring now to FIG. 6, there is illustrated an overhead schematic view of another embodiment of the DTS printer. This embodiment includes one pinning module arranged to direct output light on a polygon scanner, which can be rotated to focus light on the vessel to cure ink from a respective print head. As shown, three inkjet print heads are configured to deposit Magenta/Black ink, Yellow/Cyan ink, and White ink on the surface of the vessel while the vessel is rotated via the rotary drive assembly (not illustrated) and moved along the carriage rails (not illustrated) via the carriage rail assembly (not illustrated). As the vessel is rotated/moved, the laser pinning module is configured to provide light at an output power, for example 10 W, to sufficiently (at least partially) cure or fully cure the ink from each respective printing head deposited on the surface of the vessel to allow additional printing of colors with the printing heads. In one example, the ink is sufficiently (at least partially) or fully cured by the laser pinning module and rotating polygon scanner such that the position of the ink is maintained until the entire image or image layer has been deposited. As such, the final curing lamp can remain turned off until the vessel is moved away from the inkjet print heads (e.g., to a loading position). In the embodiment illustrated in FIG. 6, the laser pinning module and the polygonal scanner are positioned in combination to provide the light at an angle to the vessel to be printed.

As previously noted, the DTS printer is configured to print various shapes, such as cylinders and vessels having tapers (such as a pint glass, wine bottles and the like). It is appreciated that the print heads must be close to surface of the vessel to be printed. However, the diameter of the surface of the vessel to be printed can vary over the length of the vessel.

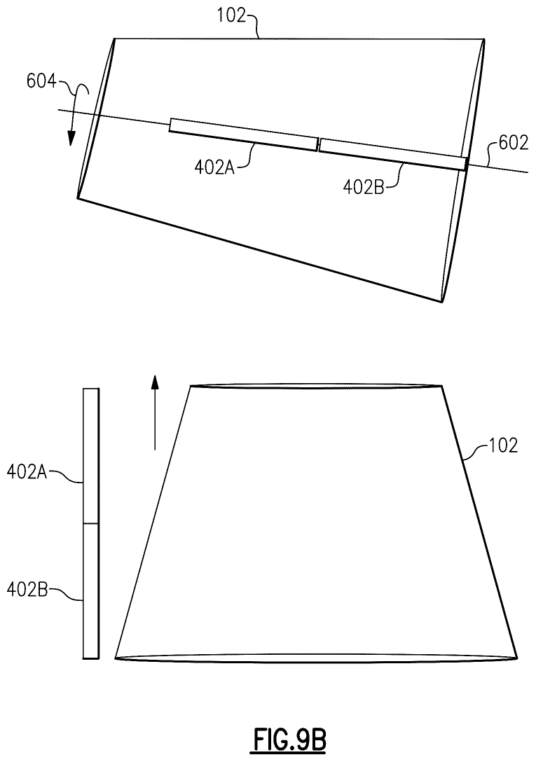

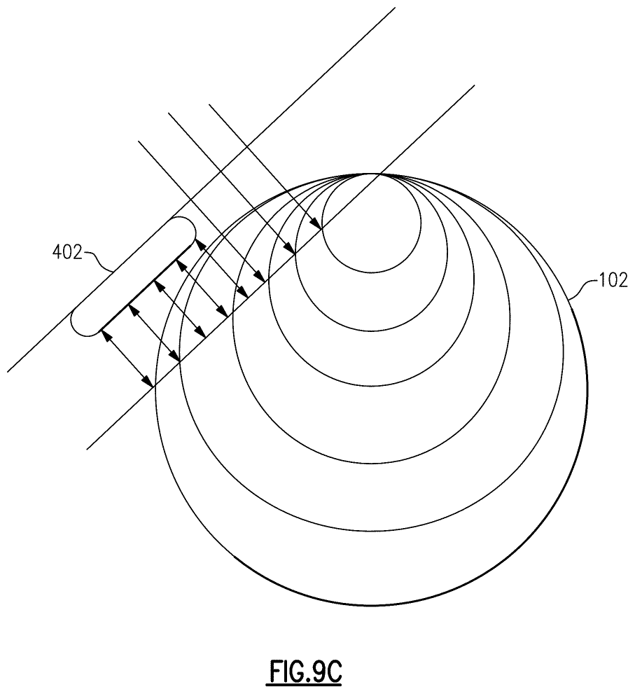

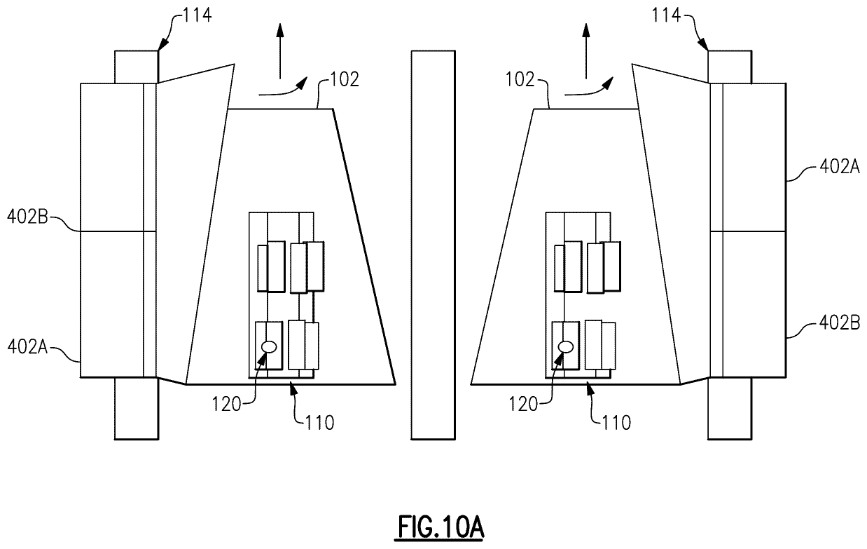

FIG. 9A illustrates multiple views of a laser pinning module 402 with respect to a vessel 102 to be printed. In some examples, the laser pinning module 402 may be positioned parallel to a motion axis 602 and/or a rotational axis 604. In one example, the motion axis 602 corresponds to the axis that the linear drive assembly 108 is configured to move the carriage rail assembly 114 (i.e., the vessel 102) along. Likewise, the rotational axis 604 corresponds to the axis of rotation that the rotary drive assembly 106 is configured to rotate the vessel 102 about (via the mandrel 116).

FIG. 9B illustrates multiple views of two laser pinning modules 402A, 402B configured and arranged with respect to the vessel 102. In some examples the two laser pinning modules 402A, 402B may be positioned in series or in parallel to a motion axis 602 and/or a rotational axis 604. In one example, the motion axis 602 corresponds to the axis that the linear drive assembly 108 is configured to move the carriage rail assembly 114 (i.e., the vessel 102) along. Likewise, the rotational axis 604 corresponds to the axis of rotation that the rotary drive assembly 106 is configured to rotate the vessel 102 about (via the mandrel 116).

As shown in FIG. 9C, the laser pinning module 402 or the laser pinning modules 402A, 402B may be positioned in parallel to the motion axis and/or the rotational axis such that the laser pinning module(s) 402 clears the maximum diameter of the vessel 102. By positioning the laser pinning module(s) 402 in parallel with the rotational axis 604, the laser pinning module(s) 402 can provide a sufficient amount of radiation at both the minimum and maximum diameters of the vessel 102.

According to aspects and embodiments, the DTS printer is configured so that the rotational axis of the vessel to be printed is raised for smaller diameters of the vessel to be printed and lowered as the diameter of the vessel increases. In particular, when printing a taper on the vessel, the vessel to be printed is tilted so that the tapered wall of the glass is parallel to the ink jet head plate, ensuring the ink jet head height is always minimized relative to the printing surface. For example, if there is a 7 degree taper angle of the vessel, the vessel is tilted 7 degrees to level the printed surface (to be parallel to the ink jet head plate). With this arrangement, the laser pinning module(s) location can be fixed.

Aspects and embodiments are directed to determining a midway point of the cross section the vessel being printed. Aspects and embodiments are directed to the vessel being fixed relative to the print heads and as the diameter of the vessel being printed gets larger and/or smaller. Aspects and embodiments are directed to adjusting the angle of the laser pinning module(s) (either manually or automatically) so as to be parallel to the vessel rotational axis to normalize the laser pinning module curing radiation over the length of a taper of the vessel. Aspects and embodiments are directed to determining and adjusting the radiation angle of the light emitted by the laser pinning module(s) to adjust the incident angle of the light from the laser pinning module(s) on the vessel (with a varying diameter) being printed. In particular, aspects and embodiments are directed to adjusting (either manually or automatically) the radial position of the laser pinning module(s) along an arc and the axial angle of the laser pinning module(s) mounting bracket to adjust the incident radiation on the vessel with varied diameters of the vessel. In addition, aspects and embodiments are directed to a laser pinning module mounting system that retains the radiation incident angle and radial positioning of the pinning light on the vessel over the range of diameters of the vessel being printed.

Aspects and embodiments are directed to a bracket that is constructed and arranged for holding and adjusting the laser pinning modules to adjust an angle of irradiation by the laser pinning modules. The bracket is configured to have an adjustable angle that is a function of any or all of: the light radiation angle leaving the laser pinning module; the midway point of the vessel to be printed as it moves with the top of the vessel fixed relative to the print heads; and/or the diameter of the vessel to be printed as it varies. In particular, the bracket is constructed and arranged to vary the angle of the incident radiation emitted by the laser pinning module on the vessel with varied vessel diameters so as to match an adjustment arc of the laser pinning module mounting bracket. In other words, a slope of movement of the laser pinning module mounting bracket provides for adjustment (automatically or manually) of the laser pinning module radiation for irradiating the mid-point (equator) of the vessel for vessels of different diameters.

In addition to positioning the laser pinning module 402 to provide an optimized incident angle θ₁, the position of the laser pinning module 402 can be adjusted to provide a desired working distance range with respect to the vessel 102. For example, the laser pinning module 402 may be positioned such that the maximum working distance for a given vessel type (e.g., long neck bottle) is within a desired operating range of the laser pinning module 402 (e.g., 0 to 20 mm). In certain examples, the desired operating range of the laser pinning module 402 may vary based on the wavelength of the UV light provided by the laser pinning module 402.

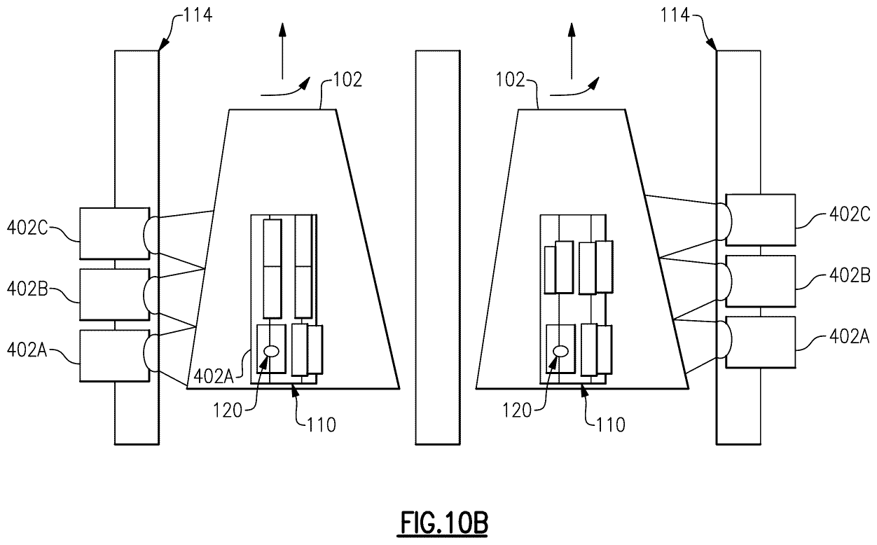

Additional aspects and embodiments of the disclosure include that the various embodiments disclosed herein, including the various laser pinning module assemblies, can be applied to high throughput DTS machines providing multiple, in parallel, imaging tunnels comprising two or more jetting paths. Such devices provide higher productivity than a single jetting tunnel. For example, FIG. 10A-10B is a schematic diagram illustrating a multiple tunnel DTS printer with each tunnel including multiple laser pinning modules in accordance with aspects described herein. It is appreciated that any of the aspects, embodiments and features disclosed herein can be applied to a multiple DTS tunnel printer. For the sake of brevity, it is understood that like reference numbers correspond to like structure as already described herein and for the sake of brevity a description of all of the elements is not repeated.

Aspects and embodiments include three laser pinning modules which can be, for example, in series to perform sufficient (at least partial) curing of ink on the vessel surface. One advantage of having three or more laser pinning modules is that the three or more laser pinning modules can be configured and controlled separately to provide less peak output power than a single laser pinning module arrangement, and to provide the total dose of light (power*time) to sufficiently (at least partially) cure the ink while also providing for less peak light being provided to the print heads so as to avoid any curing ink in the print heads. With this arrangement and the capability to independently control each laser pinning module's curing dose on the vessel, it is possible to optimize the balance of light provided while also limiting the exposure to the printheads due to reflections or stray light.

Aspects and embodiments include multiple laser pinning modules mechanically aligned in parallel. With multiple laser pinning modules, each laser pinning module is configured and to be controlled separately to provide lower peak irradiance power than a single laser pinning module arrangement, to provide for the total dose of light (power*time) to sufficiently (at least partially) cure the ink while also providing for less light amplitude being provided to the print heads so as to avoid any curing ink in the print heads. With this arrangement multiple rows of similar or longer print heads can be supported. With this arrangement and the capability to independently control each laser pinning module curing dose on the vessel, it is possible to optimize the balance of light provided while also limiting the exposure to the printheads due to reflections or stray light.

Aspects and embodiments include sufficiently curing ink printed on the vessel with at least one laser pinning module or a plurality (two or more) laser pinning modules such that the printed image on the vessel can be coated with a varnish without affecting the printed image. In particular, after the image has been printed with the ink colors (i.e., white, cyan, magenta, yellow, and black) on the vessel, the image is sufficiently cured by the laser pinning module(s), and then the image is sometimes coated with a varnish. Aspects and embodiments of the system and method include curing the printed image with the laser pinning module(s) sufficiently or fully so that the varnish doesn't affect the printed image. In contrast, it has been determined that if the printed image is not sufficiently cured and the varnish is jetted onto an uncured image, a pitted, undesirable finish results. Given this, aspects and embodiments of the system and method are configured to sufficiently (at least partially) or fully cure the ink such that coating the image with the varnish does not affect the printed image.

Aspects and embodiments of the system include a final curing lamp that is located and/or configured such that radiation from the final curing lamp doesn't reach any of the print heads and/or such that the final curing lamp is not enabled at a time that light from the curing lamp can expose the print heads, such print heads are moved away from the final curing lamps, so that the print heads are not exposed to the final curing light.

Aspects and embodiments of the system include a fixed rotating vessel with a print head carriage that moves along the axis of the vessel. With this arrangement, at least one laser pinning module is located and arranged to move with the ink jet carriage to irradiate the vessel to sufficiently (at least partially cure) an image printed on the vessel. With this arrangement, the final curing lamp can be fixed relative to the printed surface on the rotating vessel.

Aspects and embodiments are directed to the laser pinning modules distinctly positioned from the final curing lamp. Aspects and embodiments are directed to at least one laser printing module located near the print heads. It is to be appreciated that the at least one laser pinning module can also be the final curing lamp. In particular, the laser pinning module can be configured to provide a pinning power level to sufficiently cure the ink for additional printing, and after all printing is complete, the at least one laser pinning module can provide an increased final power level to finally cure the ink on the printed vessel.

Aspects and embodiments are directed to a DTS printer system that includes at least one laser pinning module, beam shaping optics, a cooling plate for cooling the at least one laser pinning system, and a pulse width modulated (PWM) controller to PWM the laser pinning radiation while limiting the thermal stress to the laser pinning module.

Aspects and embodiments are directed to a DTS printer system that includes at least one laser pinning module (including at least one laser or more than one laser in serial or parallel arrangement or a plurality of lasers in both serial and parallel arrangement) and a controller for independently controlling each laser pinning module, and/or for independently controlling each laser within each laser pinning module, and/or for controlling segments of lasers. For example, the controller can have a serial interface configured to independently control each laser pinning module, and/or independently control each laser within each laser pinning module, and/or independently control segments of lasers. The controller can be configured to independently control any and all of turning on and off each laser pinning module, to independently control pulse width and frequency modulation of each laser pinning module, to independently control amplitude of the laser signal from each laser pinning module, and to independently control power output from each laser pinning module. The controller can be configured to independently control any and all of turning on and off each laser within each laser pinning module, to independently control pulse width and frequency modulation of each laser within each laser pinning module, to independently control amplitude of the laser signal output from each laser within each laser pinning module, and to independently control power output from each laser within each laser pinning module. The controller can be configured to independently control any and all of turning on and off each segment of lasers, to independently control pulse width and frequency modulation of each segment of lasers, to independently control amplitude of the laser signal output from each segment of lasers, and to independently control power output from each segment of lasers. The controller can be configured to independently control pulse width modulation (PWM) of each laser pinning module, and/or independently control PWM of each laser within each laser pinning module, and/or to control PWM of each segment of lasers. It is appreciated that each laser pinning module can be independently turned on and off with PWM, each laser within each laser pinning module can be independently turned on and off with PWM, and/or each segment of lasers can be independently turned on and off with PWM. It is appreciated that the output power level provided by each laser pinning module can be independently controlled with PWM, the output power level provided by each laser within each laser pinning module can be independently controlled with PWM, and/or the output power level provided by each segment of lasers can be controlled with PWM. It is appreciated that the duty cycle and frequency provided by each laser pinning module can be independently controlled with PWM, the duty cycle and frequency provided by each laser within each laser pinning module can be independently controlled with PWM, and/or the duty cycle and frequency provided by each segment of lasers can be independently controlled with PWM.

Aspects and embodiments are directed to a retrofit module that can be installed in an existing DTS printer to provide laser pinning of a vessel to be printed. For example, the retrofit module can include includes at least one laser pinning module, focusing optics, a cooling plate for cooling the at least one laser pinning system, and a pulse width modulated (PWM) controller to PWM the laser pinning radiation and related connectors.

It is appreciated that some of the advantages of a DTS printing system with at least one laser pinning module, according to aspects and embodiments, include: independent control of any or all of each laser pinning module, each laser within each laser pinning module, and/or segments of lasers; limiting the thermal stress to of any or all of each laser pinning module, each laser within each laser pinning module, and/or segments of lasers; less or no reflection of energy off of the outer surface of the vessel to be printed, between the inner and outer walls of the vessel, or off of the inner surface; less or no damage to print heads; crisp dot formation and better image quality; narrow spectral wavelength of lasers signals provides superior emitting stability; less stray light results from reflections or refraction; no need to stuff bottles with light blocking materials; pulse width modulated waveform improves peak output power and pin curing effectiveness; improved peak power and power density yields less need to account for distance of source from vessel; can have multiple pinning laser signal wavelengths, powers; and the various aspects and embodiments enable printing of other types of containers, results in less ink waste, more cost effective for short runs, offers higher print quality, and supports the printing of custom applications with variable data.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only, and the scope of the disclosure should be determined from proper construction of the appended claims, and their equivalents.

What is claimed is:

1. A direct to shape (DTS) printer configured to print on a surface of a vessel, the DTS printer comprising:
a plurality of inkjet print head channels configured to deposit ink on the surface of the vessel;
a rotary drive assembly configured to rotate the vessel relative to the plurality of inkjet print head channels;
at least one laser pinning module configured to a provide light output having a first peak power density to sufficiently cure the ink deposited on the surface of the vessel to at least enable further printing on the surface of the vessel; and
a final curing module that is configured to provide light having a second peak power density to fully cure the ink deposited on the surface of the vessel.

2. The DTS printer of claim 1, wherein the second peak power density is greater than the first peak power density

3. The DTS printer of claim 1, wherein the at least one laser pinning module includes a plurality of pinning modules in series or in parallel, each laser pinning module configured and controlled separately to provide a respective output power that is less than the first peak power density over a period of time to sufficiently cure the ink for additional printing of ink.

4. The DTS printer of claim 3, wherein each laser pinning module includes at least one laser source.

5. The DTS printer of claim 1, further comprising a linear drive assembly configured to move the vessel along an axis adjacent to the plurality of inkjet print head channels.

6. The DTS printer of claim 1, wherein the rotary drive assembly is a fixed rotating assembly and further comprising a print head carriage assembly that moves along the axis of the vessel so as to print the image on the vessel.

7. The DTS printer of claim 6, wherein at least one laser pinning module is configured and arranged to move with the print head carriage assembly to irradiate the vessel to sufficiently cure an image printed on the vessel

8. The DTS printer of claim 1, wherein at least one laser pinning module is configured to sufficiently cure the ink printed image on the vessel such that the printed image on the vessel can be coated with a varnish without affecting the printed image.

9. The DTS printer of claim 1, wherein at least one laser pinning module is configured to fully cure the ink deposited on the surface of the vessel.

10. The DTS printer of claim 1, wherein the final curing module is configured to be off until the vessel is moved away from the plurality of inkjet print head channels.

11. The DTS printer of claim 1, further comprising a sensor that is located near the print head channels, that is configured to sense an amount of light exposure from the at least one laser pinning module, and that provides sensed amount of light information to a controller that is configured to control the amount of light output from the at least one laser pinning module to ensure that the level of emitted light from the at least one laser pinning module does not result in light radiation levels high enough to cure ink in the print head channels.

12. The DTS printer of claim 1, wherein at least one laser pinning module is positioned to emit light that is not perpendicular to the vessel and to the plurality of inkjet print head channels such that the light provided by at least one laser pinning module is reflected off the surface of the vessel away from the plurality of inkjet print head channels.

13. The DTS printer of claim 12, wherein the at least one laser pinning module is positioned to provide light to the surface of the vessel at an incident angle that is less than a critical angle corresponding to a material of the vessel.

14. The DTS printer of claim 1, further comprising a light trap configured to absorb or dampen the light reflected off the surface of the vessel.

15. The DTS printer of claim 1, wherein at least one laser pinning module is configured to provide the light having the first peak power density at a substantially constant level over an operational distance range.

16. The DTS printer of claim 1, wherein the position of at least one laser pinning module is configured to be adjusted such that a maximum working distance between at least one laser pinning module and the surface of the vessel is within the operational distance range of at least one laser pinning module.

17. The DTS printer of claim 1, wherein at least one laser pinning module is positioned to emit light that is perpendicular to the vessel and to the plurality of inkjet print head channels.

18. The DTS printer of claim 1, wherein at least one laser pinning module comprises three 405 nm laser diode sources.

19. The DTS printer of claim 18, further comprising a controller that independently controls Pulse Width Modulation of each of the three laser diode sources to modulate the light output from each laser diode source.

20. The DTS printer of claim 18, wherein the three laser diode sources are configured to have a beam width substantially aligned with a respective print head width.

21. The DTS printer of claim 1, wherein the at least one laser pinning module comprises at 5-50 Watt, 355 nm laser source and further comprising a polygon scanner that is configured to reflect the light from the at least one laser pinning module toward the vessel.

22. The DTS printer of claim 1, further comprising a controller that independently Pulse Width Modulates each at least one laser pinning module to modulate the light output from each at least one laser pinning module.

23. The DTS printer of claim 1, wherein the at least one laser pinning module is separate and distinct from the final curing module.

24. The DTS printer of claim 1, wherein the at least one laser pinning module is also the final curing module.

25. The DTS printer of claim 1, further comprising beam forming optics disposed at an output of the at least one laser pinning module to collimate light output from the at least one laser pinning module.

26. The DTS printer of claim 1, further comprising light absorbing material comprising an aperture disposed around the at least one laser pinning module.

27. The DTS printer of claim 1, further comprising a cooling plate assembly to cool the at least one laser pinning module.

28. A method of printing on a surface of a vessel comprising:
rotating the vessel relative to a plurality of inkjet print head channels using a rotary drive assembly;
depositing ink from the plurality of inkjet print head channels on the surface of the vessel;
providing light having a first peak power density from at least one laser pinning module to sufficiently cure the ink deposited on the surface of the vessel; and
providing light having a second peak power density from a curing module to fully cure the ink deposited on the surface of the vessel.

29. The method of claim 28, wherein the light provided by the curing module at the second peak power density is greater than the light provided by the at least one laser pinning module at the first peak power density.

30. The method of claim 28, wherein the providing light from at least one laser pinning module includes providing light from multiple laser pinning modules, each laser pinning module separately providing a respective output power that is less than the first peak power density.

31. The method of claim 28, wherein the providing light from multiple laser pinning modules includes providing light from three laser pinning modules in series.

32. The method of claim 28, further comprising moving the vessel along an axis adjacent to the plurality of inkjet print head channels with a linear drive assembly.

33. The method of claim 28, further comprising moving a print head carriage assembly along the axis of the vessel so as to print the image on the vessel.

34. The method of claim 28, further comprising moving the laser pinning module with the print head carriage assembly to irradiate the vessel to sufficiently cure an image printed on the vessel.

35. The method of claim 28, wherein the sufficiently curing with the laser pinning module comprises sufficiently curing the ink on the vessel such that the printed image on the vessel can be coated with a varnish without affecting the printed image.

36. The method of claim 28, wherein the sufficiently curing with the laser pinning module comprises fully curing the ink deposited on the surface of the vessel.

37. The method of claim 28, further comprising keeping the curing module turned off until the vessel is moved away from the plurality of inkjet print head channels.

38. The method of claim 28, further comprising sensing an amount of light exposure from the at least one laser pinning module near the print head channels and controlling the amount of light output from the at least one laser pinning module to ensure that the level of emitted light from the ate least one laser pinning module does not result in radiation levels high enough to cure ink in the print head channels.

39. The method of claim 28, further comprising adjusting a position of the laser pinning module such that the light provided by the laser pinning module is reflected off the surface of the vessel away from the plurality of inkjet print head channels.

40. The method of claim 28, further comprising providing the light having the first peak power density at a substantially constant level over an operational distance range.

41. The method of claim 40, further comprising positioning the laser pinning module such that a maximum working distance between the laser pinning module and the surface of the vessel is within the operational distance range of the laser pinning module, and wherein the maximum working distance corresponds to the position of the laser pinning module and a shape of the vessel.
